(19) United States
(12) Patent Application Publication
(10) Pub. No.: US 2007/0212002 A1
(43) Pub. Date: Sep. 13, 2007

(54) Optical module

(76) Inventor: Shunsuke Sato, Yokohama-shi (JP)

Correspondence Address: SMITH, GAMBRELL & RUSSELL, 1850 M STREET, N.W., SUITE 800, WASHINGTON, DC, 20036, US

(21) Appl. No.: 11/716,011

(22) Filed: Mar. 9, 2007

(30) Foreign Application Priority Data
Mar. 10, 2006 (JP) P.2006-0066259

(51) Int. Cl. G02B 6/36

(52) U.S. Cl. 385/92

(57) ABSTRACT

There is provided an optical module in which a process to form an optical coupling portion therein and to attach this portion to the end surface of a ferrule in an optical connector can be easily performed. Moreover, an area of the coupling portion coming in contact with the ferrule may be narrowed such that the cleaning of the area can be easily done in a short time. The optical module includes a sleeve assembly that comprises a cylindrical member and a sleeve member with a sleeve to guide the ferrule and a pocket in the deep end of the sleeve to receive the pocket. The sleeve has a bore with the first diameter, while, the pocket has another bore with the second diameter smaller than the first diameter. The cylindrical member comes into direct contact with the end surface of the ferrule. An entire portion of the cylindrical member is uniformly formed.

### CROSS REFERENCE TO RELATED APPLICATIONS

This application is based on and claims the benefit of priority from the prior Japanese Patent Application No. 2006-066259, filed on Mar. 10, 2006, the entire content of which is hereby incorporated by reference.

### BACKGROUND OF THE INVENTION

1. Field of the Invention

The present invention relates to an optical module for connecting an optical connector.

2. Related Prior Art

In an optical model applicable in an optical communication system using an optical fiber, an optical signal generated by a light-emitting device such as a semiconductor laser diode (LD) is transmitted through the optical fiber, or light transmitted through the optical fiber is received by an optical device such as a semiconductor photodiode (PD). The light from the LD is necessary to be converged on a core of the optical fiber. In the PD, the light transmitted through the core of the optical fiber is converged by a lens and converted to an electrical signal.

The optical module includes an optical device that installs the semiconductor optical device, a sleeve assembly that performs an optical coupling between the semiconductor optical device and the optical fiber, and a J-sleeve for aligning the optical device with the sleeve assembly. FIG. 7 is a sectional view showing one example of a conventional sleeve assembly. As illustrated in FIG. 7, the conventional sleeve assembly 6 has a rigid sleeve 61 attached to a housing 60 and a stub 62 provided within the rigid sleeve 61. The rigid sleeve 61 has a function to guide a ferrule, which is not shown in FIG. 7, of an optical connector to optically connect with the optical device.

The stub 62 basically has the same structure as that of the ferrule in the optical connector and has a single mode fiber (SMF) as the coupling fiber secured in a micro-bore provided in a center portion of zirconia ceramics or the like. The stub 62 is used in a transmitter optical sub-assembly (TOSA) and a receiver optical sub-assembly (ROSA) in the same configuration.

That is, an end surface 62b in a side of the optical device is polished oblique with respect to an optical axis connecting the optical device with the optical fiber by an angle from 5° to 10° such that the light due to the Fresnel reflection occurred at an interface to air does not return to the same direction as that of the optical axis. While, the stub 62 has another end surface 62a of a side to the optical connector, in which the surface 62a is polished in a convex shape similarly to the ferrule, which realizes a physical between the surface 62a and the ferrule. Since the coupling fiber 62c in the stub 62 has a same refractive index as that of the optical fiber, the Fresnel reflection at the interface becomes quite small as low as −40 dB or less.

The stub 62 and the ferrule of the optical connector are inserted into the bore 61a of the sleeve 61. Both the end surface 62a of the stub 62 and the surface of the ferrule have a convex shape with a curvature thereof from 10 mm to 20 mm. Then, each portion close to the core of the optical fibers in the stub 62 and the ferrule may be elastically deformed such that the optical fibers come into physical contact therebetween.

As described, when the coupling fiber in the stub is optically coupled with the optical fiber of the ferrule with small dust existing on the end surface 62a or the end surface of the ferrule, the dust is sandwiched between the stub 62 and the ferrule, which the optical coupling between the fibers, namely, the PC contact may be prevented. Therefore, the end surface 62a of the stub 62 or the surface of the ferrule is always necessary to be clean with no small dust. For the ferrule, the end surface thereof may be easily cleaned because the surface itself protrudes from the body. However, for the stub 62, it may be quite hard to clean the surface thereof 62a because the stub 62 exits in the deep end of the sleeve 61. Accordingly, when the end surface 62a of the stub 62 is cleaned, it is necessary to use, for instance, a stick type cleaner.

Further, the United States Patent published as US2004/086233A has disclosed a method to use a flat glass plate in place of the stub. FIG. 8 is a schematic cross section showing the sleeve assembly disclosed in US 2004/086233A.

In a sleeve assembly 7 shown in FIG. 8A, a top tubular portion of a sleeve, where the tubular portion is integrated with the housing, is covered with a glass plate 72 in the side of the optical device. Further, the glass 72 is secured in the housing by a topper 73 that is fitted thereto and provides with an aperture so as to include an optical axis. Then a ferrule attached to a tip of the optical fiber is guided to an end surface 72a of the glass 72 by the sleeve 71 such that the ferrule comes into PC contact with the glass 72. Thus, the reflection of light at the end surface 72a, accordingly, the returning of the light from the surface can be suppressed.

Also in the sleeve assembly 7, when dust exists on the end surface 72a of the glass or on the surface of the ferrule, the physical contact therebetween may be prevented. Therefore, in this assembly, the end surface 72a is always required to be clean. Especially, an area to be cleaned extends from the wall 71a of the sleeve 71 to the glass 72, which makes it quite hard to maintain the cleanness in such wide area.

The sleeve assembly 8 shown in FIG. 8B has the arrangement that the ferrule comes in contact with the glass 82, which is similar to the assembly 7 shown in FIG. 8A. However, the outer diameter of the glass 82 is smaller than the bore of the sleeve 81. In the sleeve assembly 8, the sleeve 81 is formed independently of a shell 80. The end surface 82b of the glass 82 is attached to a stopper that holds the sleeve 81 by surrounding the outer wall 81a thereof. Then, the LD or the PD may be installed in a side of the end surface 82b of the glass 82, while, the sleeve 81 guide the ferrule to the end surface 82a of the glass 82.

However, in the case that the stub illustrated in FIG. 7 is applied, or that the glass shown in FIG. 8A is used as a bottom plate of the sleeve, the outer diameter of the stub 62 us necessary to be processes to a dimension equal to that of the outer diameter of the ferrule. It is quite difficult, when a rigid sleeve 61 or a split sleeve is used as the sleeve, not only to reduce the outer diameter of the stub but also to provide a surplus area in a periphery of the stub for sweeping away and accumulating dust on the surface of the stub therein as in the configuration shown in FIG. 8B. Further, although an area of the glass to be cleaned in the structure shown in FIG. 8B can be narrowed; the diameter of the ferrule is merely 1.25 mm or so. Thus, the glass is hardly processed so that the glass has one side smaller than the diameter of the ferrule.

The present invention is carried out by considering the above-described circumstances and an object of the present invention is to provide an optical module that may easily and accurately perform to process the module and to attach an optical connecting portion thereof to the end surface of a ferrule. Moreover, the module has a surface of the connecting portion may be formed as a narrow area such that a cleaning may be easily and promptly done.

### SUMMARY OF THE INVENTION

An optical module according to the present invention, which mates with an optical connector, comprises a sleeve member and a cylindrical member. The sleeve member includes a sleeve and a pocket in a deep end of the sleeve. The sleeve guides a ferrule of the optical connector and has a bore with a first diameter. The pocket, where the cylindrical member is set therein, has another bore with a second diameter smaller than the first diameter. The cylindrical member in the pocket comes into direct contact with the end surface of the ferrule to suppress the Fresnel reflection at the interface therebetween. An entire portion of the cylindrical member is optically uniformly formed. The sleeve member may be divided into the sleeve and a bush provided with the pocket. Further, the sleeve assembly may further provide a shell to cover the sleeve and the bush. The bush may be press-fitted into the sleeve and the assembly of the bush with the sleeve may be fitted into the shell.

### BRIEF DESCRIPTION OF DRAWINGS

FIG. 1A is a sectional view showing a process that a cylindrical member is assembled to a sleeve assembly to form an optical module of the present invention, and FIG. 1B is a sectional view showing that the cylindrical member is assembled to the sleeve assembly;

FIG. 2A is a partly broken perspective view showing a process that the cylindrical member assembled to from the sleeve assembly, and FIG. 2B is a partly broken perspective view showing the assembled sleeve assembly;

FIG. 3A is a perspective and sectional view showing a process that a ferrule is inserted into the sleeve assembly shown in FIG. 2B, and FIG. 3B is a partly broken sectional view of the sleeve assembly when the ferrule is completely inserted;

FIG. 4A is a sectional view showing the sleeve assembly when the ferrule shown in FIG. 3B is completely inserted, and FIG. 4B is a sectional view schematically showing the sleeve assembly where light output from the optical fiber is reflected with nth cylindrical member;

FIG. 5A is an exploded view showing an example of a cylindrical member, a sleeve and a bush according to another embodiment of the present invention, and FIG. 5B is a sectional view showing the sleeve assembly when the cylindrical member and the bush are assembled to form the sleeve assembly;

FIG. 6A is an exploded view showing an example of a cylindrical member, a sleeve and a bush according to still another embodiment of the present embodiment, FIG. 6B is a sectional view showing a process that the cylindrical member, the sleeve and the bush are assembled with a sleeve shell, and FIG. 6C is a sectional view showing the completion of the sleeve assembly;

FIG. 7 is a sectional view showing a conventional sleeve assembly; and

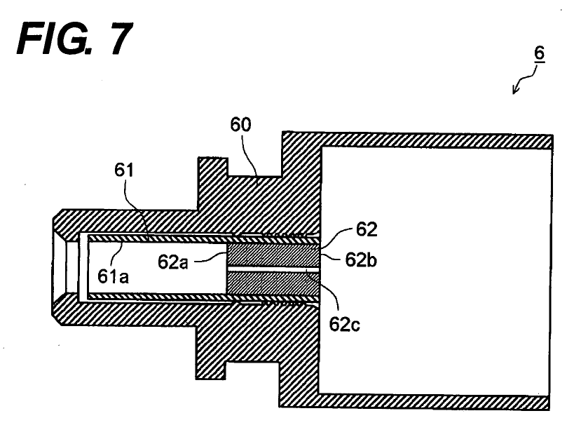

FIGS. 8A and 8B are sectional view showing another conventional sleeve assembly.

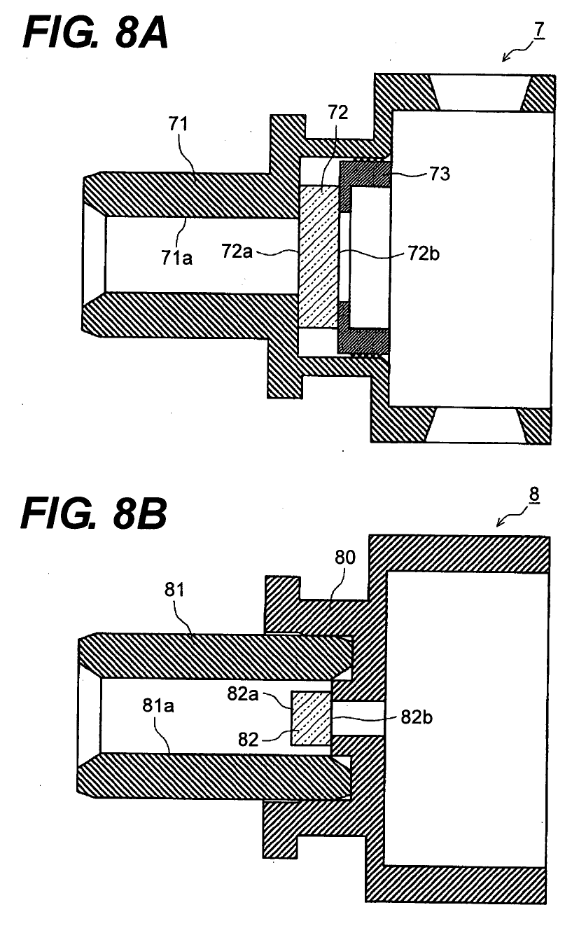

### DESCRIPTION OF PREFERRED EMBODIMENTS

### First Embodiment

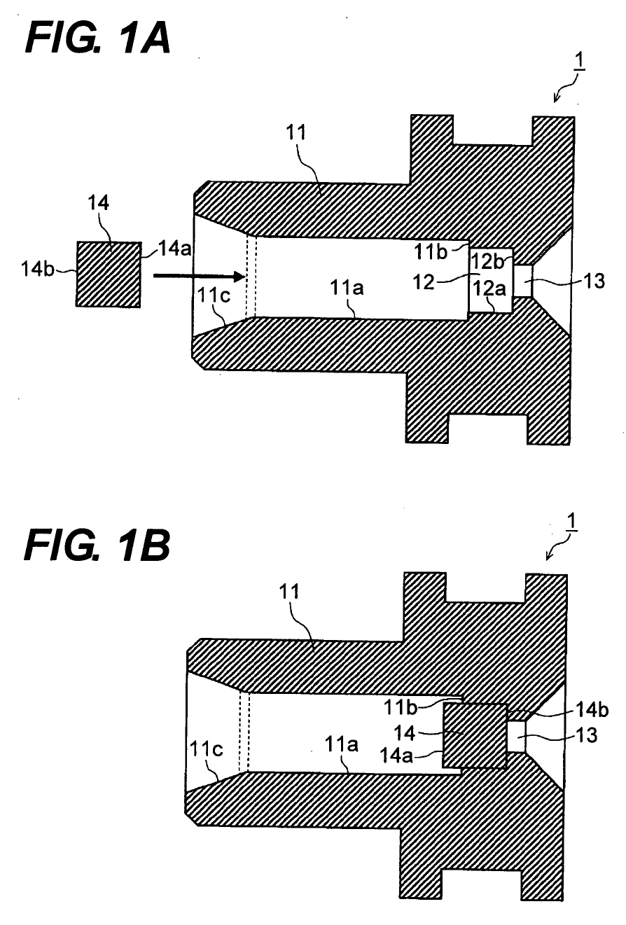

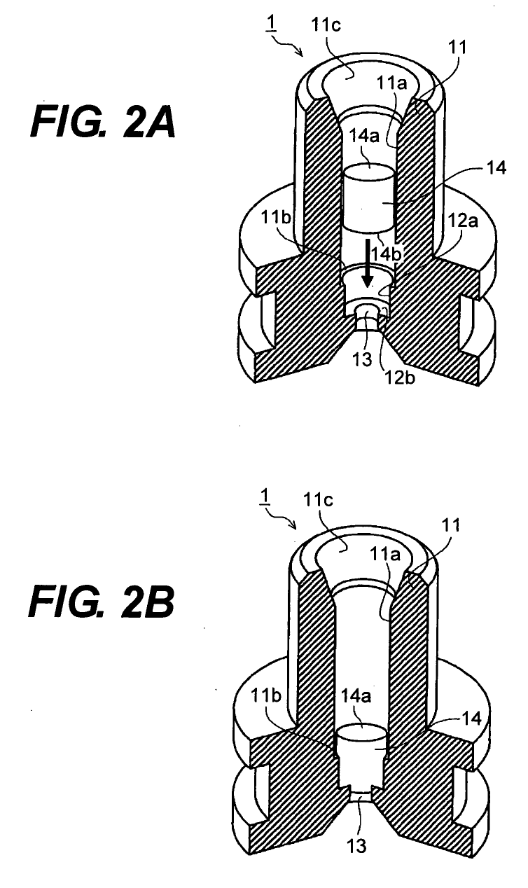

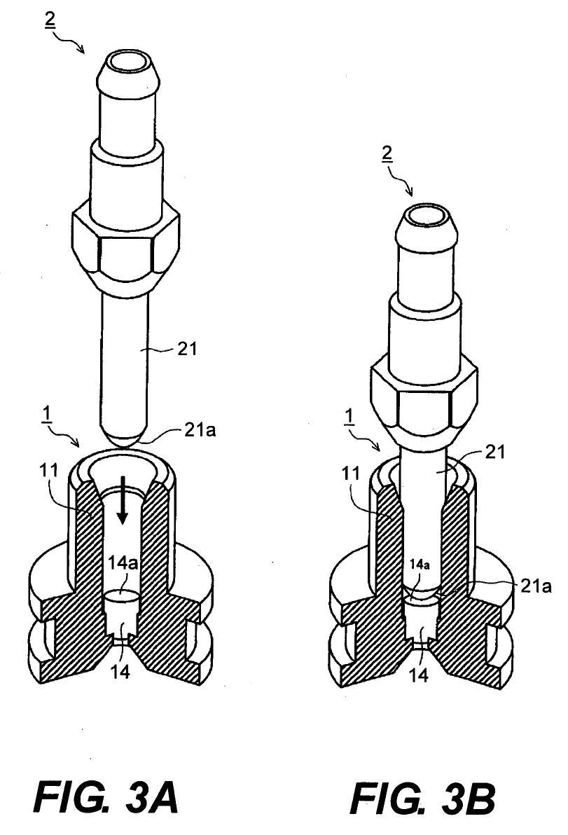

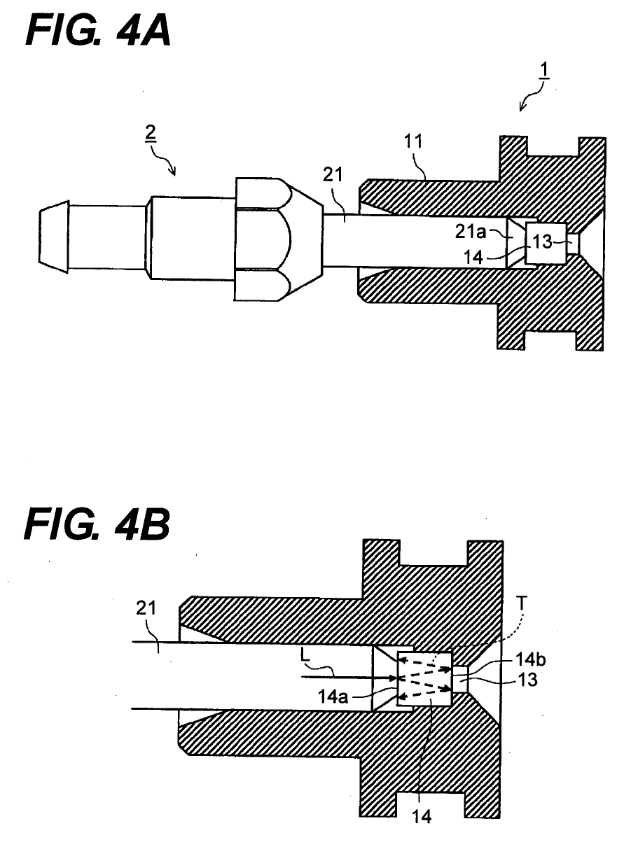

FIG. 1 is a sectional view showing an example of a sleeve assembly using cylindrical member in an optical module of the present invention. FIG. 2 is a perspective and sectional view of the sleeve assembly shown in FIG. 1. FIG. 3 is a perspective and sectional view showing a process that a ferrule is inserted in to the sleeve assembly shown in FIG. 2. FIG. 4 is a sectional view schematically showing a trace of light transmitted in an optical fiber in the cylindrical member shown in FIG. 3.

The optical module according to the present invention includes a sleeve assembly 1 having a sleeve member 11 and a cylindrical member 14. The sleeve assembly 1 may further include an optical device that installs a semiconductor optical device such as an LD or a PD, which is not shown in the drawings.

The sleeve assembly 11 guides a ferrule 21 attached to a tip of an optical connector 2 as shown in FIG. 3 by a bore 11a into which the ferrule 21 is fitted. The bore la has a first diameter and a function of a sleeve. Although the optical connector 2 exposes the ferrule 21 in FIG. 3, the shell of the optical connector 2 actually covers the ferrule 21. The ferrule 21 secures the optical fiber at a center thereof. An end 21a of the ferrule is processed to a convex shape.

Further, the sleeve assembly 11 preferably has a chamfered aperture 11c to easily insert the ferrule 21 into the sleeve assembly 11, or to hardly chip the end 21a of the ferrule 21 or the end of the sleeve assembly 11 as shown in FIG. 1. When the sleeve assembly 11 receives the ferrule 21 by the bore 11a thereof, the ferrule 21 rubs the side of the bore 11a to cause broken pieces.

The sleeve member 11 has pocket 12 to receive the cylindrical member 14 in the deep end. The deep end of the bore 11a provides a bottom 11b. The pocket 12 receives the side of the cylindrical member 14 on the bore 12a thereof and the end surface 14b on the bottom 12b thereof. Further, the bore of the pocket 12 has a second diameter smaller than that of the bore 11a.

Here, the bore 12a that secures the side of the cylindrical member 14 preferably has the same accuracy as the outer diameter of the cylindrical member 14, so that an axial deviation of the cylindrical member 14 relative to the optical axis may be decreased and the inclination of the optical axis between that of the sleeve assembly 11 and that of the cylindrical member 14 may be suppressed.

The bottom 12b of the pocket 12 receives a pressure in a direction along the optical axis applied through the cylindrical member 14. The bottom 12b further includes an aperture 13 to pass the light emitted from the optical fiber to the PD installed in the optical device or the light emitted from the LD in the optical device to the optical fiber.

Ordinarily, the pressure appeared in the direction along the optical axis by a spring in the optical connector is designed to exert on the ferrule 21 and the end portion thereof. When the optical connector engages with other optical connector, optical coupling efficiency is prevented from being degraded. For example, the LC type optical connector rules, in the standard thereof, the pressure to be 10 Newton to apply thereto. In the sleeve assembly 1, the bottom 12b of the pocket 12 receives this pressure through the cylindrical member 14. Further, when the sleeve assembly 11 sets the cylindrical member 14 with an adhesive, a positional deviation due to the expansion during a solidification of the adhesive, which is called as the creep, is to be considered. However, it is unnecessary to consider the creep of the adhesive by the bottom 12b. Accordingly, the bottom 12b is preferably provided as the receiving portion of the cylindrical member 14 as shown in FIG. 1.

Further, the depth of the pocket 12, which is the depth in the inserting direction of the cylindrical member 14 shown by an arrow in FIG. 1A, is smaller than the height of the cylindrical member 14. Thus, when the pocket 12 receives the cylindrical member 14, the end 14a of the member 14 protrudes from the bottom 11b of the sleeve assembly 11 toward the side of the aperture 11c.

It is preferable to process in a same time the bore 11a of the sleeve assembly 11, which receives the ferrule 21, and the bore 12a of the pocket 12, which receives the cylindrical member 14. For instance, the continuous processing may be applicable when the process is performed by the metal machining, while, an integrated die including each bores, 11a or 12a, may be applicable for the injection molding of resin or ceramics. Thus, the coincidence of the axes of the sleeve member 11 and the cylindrical member 14 can be secured, which accurately positions the cylindrical member 14 with respect to the sleeve 11. The sleeve 11 is preferably made of material that makes the accuracy compatible with the strength, such as metal, amorphous metal, ceramics, a resin, and so on.

When the pocket 12 receives the cylindrical member 14, the cylindrical member 14 may be inserted into the sleeve assembly 11 along a direction shown in the arrow in FIGS. 1A and 2A, and is set within the pocket 12 as shown in FIG. 1B and FIG. 2B. For the setting of the cylindrical member 14 to the pocket 12, various methods in addition to the bonding may be applicable, such as the fitting and the thermo-compressing. It is further preferable to simplify the assembly that the cylindrical member 14 may be press-fitted into the pocket 12.

Next will describe the detail of the cylindrical member 14.

The drawing of the fused glass may produce the cylindrical member 14, which can not only maintain the accuracy of an outer diameter but also reduce the process cost thereof. To cut a long-drawn glass in a plurality of pieces each having a predetermined length forms the cylindrical member 14. The ends, 14a and 14b, of the cylindrical member 14 are processed in perpendicular to the side of the member 14 and are polished in a plane so as not to generate the reflection due to micro irregularities.

Further, the cylindrical member 14 has a diameter smaller than the bore 11a of the sleeve assembly 11, which is equivalent to the outer diameter of the ferrule, and both ends, 14a and 14b, in the area thereof narrower than the bottom 11b of the bore 11a, which reduces an area to be cleaned. Further, the cylindrical member 14 has an aperture and a thickness so as not to attenuate the light emitted from the optical fiber or from the optical device in the cylindrical member 14.

The cylindrical member 14 is optically uniformly made of material with a refractive index thereof same as that of the optical fiber to reduce the reflection due to the difference in the refractive index of both materials at the interface between the cylindrical member 14 and the optical fiber. The Fresnel reflection inevitably occurred at the interface between two materials due to the difference in the refractive index may be reduced by setting the material of the cylindrical member 14 with the refractive index substantially equal to that of the optical fiber. Accordingly, the cylindrical member 14 preferably has the refractive index equal to the refractive index of the core of the optical fiber within a range of ±0.11.

The Fresnel reflection RF is calculated by the following:
RF=10·log₁₀{(n₁−n₂)²/(n₁+n₂)²}[dB].
Here, n₁ is the refractive index of the core of the optical fiber and n₂ is the refractive index of the cylindrical member 14. One international standard rules the level of the Fresnel reflection RF to be below −27 dB at the boundary between the optical fiber and the cylindrical member 14. The reflected light returns back to the core. Thus, according to the equation above, to make the refractive index of both materials substantially equal to each other, the core of the optical fiber and the cylindrical member 14, in a range of ±0.11 may reduce the level of the Fresnel reflection below −27 dB.

FIG. 4A is a sectional view showing a process that the sleeve member 11 receives the ferrule 21 and the end of the ferrule 21 comes in physically contact with the cylindrical member 14. FIG. 4B, which shows a portion where the ferrule 21 comes in contact with the cylindrical member 14, is a light tracing diagram illustrating how the light transmitted through the optical fiber is reflected within the cylindrical member 14. Here, the numerical aperture NA of the light output from the optical fiber is assumed to be 0.1.

The light L transmitted in the optical fiber is reflected at the end 14b of the member 14 in the side of the optical device by the Fresnel reflection due to the difference in the refractive index between the cylindrical member 14 and the air, which is illustrated by the trace T that transmits in the cylindrical member with the aperture NA, which shows a different situation from the reflection at the other end 14a to the ferrule. To enlarge the thickness of the cylindrical member 14 may suppress the magnitude of the light that couples with the ferrule again after the reflection within the cylindrical member 14.

That is, the end 14b of the cylindrical member 14 generates the reflection, which is about −14 dB, by the difference in the refractive index between the member 14 and the air. However, because the reflected light is diffused in the cylindrical member 14, to enlarge the thickness of the member 14 may reduce a portion of light that couples again with the optical fiber. Moreover, even in a light-receiving module, to make the end 14b oblique to the optical axis may reduce the light reflected thereat and transmitted in the cylindrical member 14 to couple again with the optical fiber in the ferrule 21.

The cylindrical member 14, which is formed by the drawing as explained above, preferably has an outer diameter smaller than 1.25 mm, which is a diameter of the sleeve, for example, between 0.7 mm to 1.0 mm. Moreover, the drawing may maintain the accuracy of the diameter of the material below several μm. While, the length of the member 14, namely, the thickness thereof may be determined based on the ratio of the light returning the optical fiber reflected at the end surface 14b. Considering the numerical aperture of the optical fiber, the length of the cylindrical member 14 about 1 mm may reduce the light coupled with the optical fiber again to a level substantially neglected.

It is preferable for the cylindrical member 14 to be made of material with high hardness, which may suppress and reduce scratches and chippings due to the deviated insertion into or extraction from the ferrule 21, or scratches induced on the end surface at the cleaning. Further, to harden the surface of the cylindrical member 14 with, for instance, a diamond like carbon (DLC) may further suppress and reduce the scratches.

As described above, the optical module according to the present invention may not only make it easy and prompt to process the optical coupling portion with the ferrule but also possible to clean the optical coupling surface by narrowing the area thereof.

### Second Embodiment

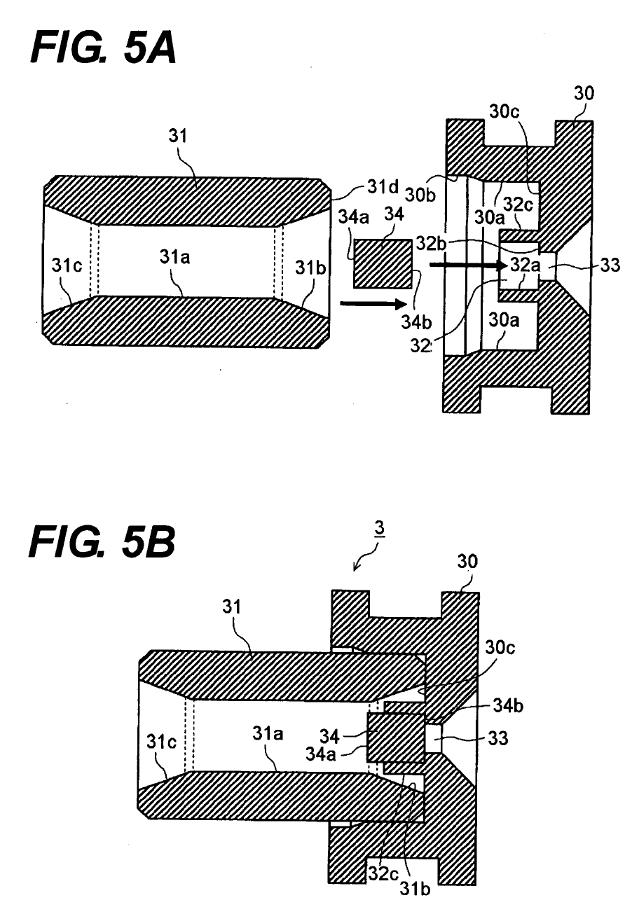

FIG. 5 is a sectional view showing an example of a sleeve assembly with a cylindrical member according to another embodiment of the present invention. FIG. 5A is an exploded view of the second embodiment, while FIG. 5B is a process to assemble the module.

The optical module according to the second embodiment also includes sleeve assembly 3 that comprises the sleeve 31 and the cylindrical member 34 similar to those described as referring to FIGS. 1 to 4. The sleeve assembly 3 in the present embodiment further provides a bush 30 to form a pocket 32 that receives the cylindrical member 34 in one end thereof. Here, the explanation of the present embodiment omits the overlapping explanation for the same portions as those of the previous module shown in FIGS. 1 to 4.

The sleeve assembly 3 of the present embodiment provides the bush 30 to hold the sleeve 31, and the bush 30 forms the pocket 32. The sleeve 31 is preferably press-fitted into the bush 30.

Components constituting the sleeve assembly 3 will be described in detail. The cylindrical member 34 has the same configuration as the previously described member 14. The sleeve 31, which guides the ferrule, provides a bore 31a which mates with the ferrule. The sleeve 31 preferably forms the enlarged aperture 31c, namely, the tapered shape, to easily insert the ferrule therein and to hardly chip the edge of the ferrule or that of the sleeve 31. It is also preferable for the end 31d of the sleeve 31, which is inserted along the arrow illustrated in FIG. 5A and set in the bush 30, to form the tapered aperture 31b.

The bush 30 has a bore 30a that fits to the outer shape of the sleeve 31 and the bottom 30c to which the end 31d of the sleeve abuts when the sleeve 31 is inserted in the bush 30. The bush 31 also preferably provides the enlarged aperture 30b in the bore 30a thereof.

The pocket 32 in the bush 30 receives the side and the end surface 34b of the cylindrical member 34 by the bore 32a and the bottom 32b thereof, respectively, which operates as the receiver for the cylindrical member 34. However, the outer wall 32c of the pocket 32 faces the inner wall 30a of the bush to form a space for receiving the sleeve 31. Thus, the pocket 32 may also configure the cylindrical shape. The bottom 32b to abut against the end 34b of the cylindrical member 34 operates as the receiver for the cylindrical member 34 and continues to the aperture similar to those shown in FIGS. 1 to 4.

The process for assembling the module according to the second embodiment described above, as illustrated in the arrow in FIG. 5A, includes steps of: firstly, inserting the cylindrical member 34 into the pocket 32 in the bush 30 and setting thereto, and secondly, inserting the sleeve 31 into the space between the outer wall 32c of the pocket 32 and the inner wall 30a of the bush and setting thereto. The setting may be performed by the bonding, the press-fitting and the thermal-compressing. The press-fitting preferably carries out the assembly.

The sleeve assembly according to the present embodiment, as described above, provides the sleeve 31 and the bush 30 independently to each other. Accordingly, the module of the present embodiment has advantages, in addition to those described in connection with the previous embodiment shown in FIGS. 1 to 4, for the bush 30 make it possible to reproduce a complicated shape thereof and to be made of metal with high stiffness. The sleeve 31 is preferably made of ceramics with high sliding ability, in particular, the sleeve 31 may be rigid sleeve made of ceramics. The sleeve 31 has a simple symmetrical and cylindrical shape. The metal bush 30 may enhance the shielding effect for the electromagnetic interference (EMI) noise caused by the optical device. The bush 30 connects the optical device through the joint sleeve (J-sleeve), which are not shown if the figure. Both the J-sleeve and the CAN package of the optical device are ordinarily made of metal, which may suppress the EMI noise coming from the outside of the module and influencing the optical device, and the EMI noise generated by the optical device or the electronic circuit to drive the optical device from leaking out the module through the aperture of the sleeve 31.

### Third Embodiment

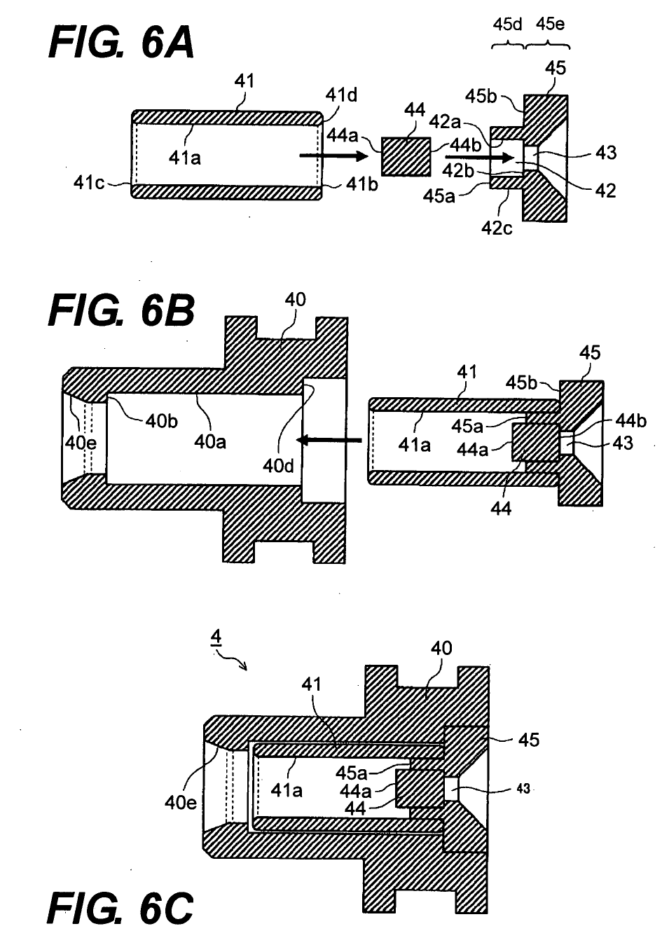

FIG. 6 is a sectional view showing an optical module according to the third embodiment of the present invention. FIG. 6A is an exploded view of a sleeve assembly, FIG. 6B is a process to build the sleeve assembly and the sleeve shell, and FIG. 6c shows the completion of the assembly.

The optical module shown in FIG. 6 provides, similar to the module according to the first embodiment shown in FIGS. 1 to 4 and that according to the second embodiment shown in FIG. 5, the sleeve 41, the bush 45 and the cylindrical member 44 as the sleeve assembly 4. The bush 45 forms the pocket 42 with a cylindrical bore 42 in one end thereof. The explanation of the present module will omit the overlapped description for portions with the same configurations and the functions as those of the modules shown in FIGS. 1 to 5.

The sleeve assembly 4 in the present embodiment provides, in addition to the sleeve 41, the bush 45 to hold the sleeve 41 and the shell 40 to cover the sleeve 41. The bush 45 includes the first portion 45d and the second portion 45e. The first portion 45d forms the pocket 42. The sleeve assembly 4 of the present embodiment corresponds to those shown in FIG. 5 where the sleeve 31 is divided into the sleeve 41 and the shell 40 and the bush 30 is divided into the bush 45 and the shell 40. The bush 45 in the outer wall 42c of the first portion 45d is press-fitted into the bore 41a of the sleeve 41 and in the second portion 45e thereof is press-fitted into the shell 40.

Components constituting the sleeve assembly 4 will be described. First, the cylindrical member 44 has the similar configuration as that of the members, 14 and 34, in the previous embodiments. The sleeve 41 is to guide the ferrule and has a bore 41a which mates with the ferrule. The sleeve 41 and the shell 40 are preferably provides the tapered aperture 40e as shown in FIG. 6 to easily insert the ferrule into the aperture 40e of the shell 40 and into the sleeve 41, and to hardly chip the end of the ferrule or that of the sleeve 41. The sleeve 41, which is inserted in to the bush 45 along the arrow shown in FIG. 6A and set thereto, also preferably has the tapered aperture 41d in the end of the bush 40 to easily insert the bush 45 therein and to hardly chip the edge 41d of the sleeve 41. The bush 45 forms the wall as the outer wall 42c of the pocket 42, which fits to the bore 41a of the sleeve 41, and also provides the surface 45b at the boundary between 45d and the 45e that, when the sleeve 41 is inserted thereto, abuts against the end 41d of the sleeve 41.

The pocket 42, similar to those shown in FIGS. 1 to 5, receives the side and the end 44b of the cylindrical member 44 by the bore 42a and the deep end 42b thereof, respectively. The outer wall 42c of the pocket 42, as described above, has a shape to fit with the bore 41a of the sleeve 41. Further, the deep end 42b that abuts against the end 44b of the member 44, similar to those shown in FIGS. 1 to 5, operates as the stopper for the cylindrical member 44 and provides the aperture 43.

The shell 40 provides the bore 40a which receives the sleeve 41 and the bush 45. The bore 40a of the shell 40 forms a step 40d that abuts against the surface 45b of the bush 45 and a flange 40b that covers the end 41c of the sleeve 40.

The process to build the sleeve assembly 4 is; firstly, inserting the cylindrical member 44 into the pocket 42 in the bush 45 and setting thereto, and secondly, fitting the sleeve 41 in the bore 41a thereof into the outer wall 42c of the pocket 42, as shown in the arrows in FIG. 6A. Thirdly, the sleeve 41 built with the bush 45 is put within the bore 40a of the shell 40 to complete the assembly. The setting of members may be performed by the bonding, the press-fitting, and the thermo-compressing. The press-fitting is preferable for the simplicity of the process.

In the present embodiment, the sleeve assembly comprises the sleeve 41, the bush 45 and the shell 40. The sleeve 41 that receives and mates with the ferrule may be a rigid sleeve made of widely-used ceramics similar to those described in connection with the former embodiments. Accordingly, the present module has advantages, in addition to those explained in FIG. 5, to make it possible to form the sleeve 41, the bush, and the shell in a complex shape, and to enhance the dimensional accuracy and the shielding performance.

Actually, both the inner and outer walls, 42a and 42c, of the pocket 42, in other words, the bore 42a to support the cylindrical member and the outer wall 42c to support the sleeve 41 becomes important in the dimensional accuracy thereof. Other portions that require the dimensional accuracy is a portion where the shell 40 comes in contact with the bush 45. That is, the bore 42a requires the dimensional accuracy to receive and support the cylindrical member 44, while, the outer wall 42c requires the dimensional accuracy to fit the assembly of the bush 45 with the member 44 into the sleeve 41. On the other hand, the bush 45 in the root thereof and a portion corresponding thereto in the shell 40 requires the dimensional accuracy, in particular, the accuracy of the diameter thereof. The bush 45 made of metal or resin may easily secure the accuracy described above.

While the invention has been described in connection with the exemplary embodiments, it will be obvious to those skilled in the art that various changes and modification may be made therein without departing from the present invention, and it is aimed, therefore, to cover in the appended claims all such changes and modifications as fall within the spirit and scope of the present invention.

What is claimed is:

1. An optical module including a semiconductor device within an optical device and a sleeve assembly to optically couple the semiconductor optical device with an optical fiber secured in an optical connector that is mated with the sleeve assembly, the sleeve assembly comprising:
a sleeve member including a sleeve and a pocket, the sleeve guiding a ferrule attached to the optical fiber in the optical connector, the sleeve having a first bore with a first diameter, the pocket being formed in a deep end of the sleeve and having a second bore with a second diameter smaller than the first diameter; and
a cylindrical member set in the pocket, the cylindrical member having a first surface abutting against the optical fiber in the optical connector,
wherein the cylindrical member is optically uniformly formed.

2. The optical module according to claim 1,
wherein the cylindrical member is made of glass.

3. The optical module according to claim 1,
wherein the sleeve is made of resin and the cylindrical member is press-fitted within the pocket.

4. The optical module according to claim 1,
wherein the second bore of the pocket has a depth smaller than a length of the cylindrical member to protrude the cylindrical member into the first bore of the sleeve, and
wherein a gap is formed between the cylindrical member and an inner wall of the first bore of the sleeve.

5. The optical module according to claim 1,
wherein the sleeve and the pocket are integrally built.

6. The optical module according to claim 1,
wherein the sleeve assembly further comprises a bush, the pocket being formed in the bush, and
wherein the sleeve is fitted to the bush so as to surround the pocket and the cylindrical member in the pocket.

7. The optical module according to claim 1,
wherein the sleeve assembly further comprises a shell for covering the sleeve and the pocket.

8. The optical module according to claim 7,
wherein the sleeve assembly further comprises a bush having a first and second portions, the first portion providing the pocket with the second bore and being fitted into the sleeve and
wherein the second portion is fitted into the shell.
